(19) United States
(12) Patent Application Publication
(10) Pub. No.: US 2024/0381294 A1
(43) Pub. Date: Nov. 14, 2024

(54) INDOOR POSITIONING ENABLED SYSTEMS AND METHODS

(71) Applicant: SIGNIFY HOLDING B.V., EINDHOVEN (NL)

(72) Inventors: MARK HENRICUS VERBERKT, EINDHOVEN (NL); JULES MARTINUS ADRIANUS GERARDUS DE LAAT, BOXTEL (NL); MAHESH NANJAPPA BANDAKKA, BANGALORE (IN); JOHANNES ANTONIUS WILHELMUS MARIA VAN CRANENBROEK, BUDEL (NL); MENG ZHAO, EINDHOVEN (NL)

(21) Appl. No.: 18/691,914

(22) PCT Filed: Sep. 13, 2022
(86) PCT No.: PCT/EP2022/075336

§ 371 Date: Mar. 14, 2024

(30) Foreign Application Priority Data
Sep. 17, 2021 (IN) 202141042119
Feb. 24, 2022 (EP) 22158591.2

(51) Int. Cl. H04W 64/00

(52) U.S. Cl. CPC H04W 64/00

(57) ABSTRACT

The systems and methods described herein relate to indoor positioning systems and methods of performing high accuracy indoor positioning. More specifically, provided are indoor positioning systems comprising a positioning platform communicatively coupled to a backend device that utilizes coded location identifiers and indoor positioning datasets generated by the backend device to determine the position of a mobile device operating the positioning platform to a high degree of accuracy. In embodiments, the indoor positioning system can include a plurality of geolocation beacons distributed throughout one or more buildings that emit location identifiers for use in determining the mobile device's location. Also provided are methods of detecting an indoor position of a mobile electronic device within an environment having multiple positioning-enabled buildings located closely together.

### FIELD OF THE DISCLOSURE

The present disclosure is directed generally to indoor positioning systems and methods, and specifically to indoor positioning enabled systems and methods for detecting position data of one or more devices in areas with multiple structures located closely together.

### BACKGROUND

In various settings, it is desirable to be able to detect and track the position of a device or its user within a structure, such as inside a building. However, indoor positioning systems can be computationally heavy on mobile devices, which can negatively impact the end user's experience. Such indoor positioning systems suffer from poor accuracy and end user experience, among other issues.

### SUMMARY OF THE DISCLOSURE

According to an embodiment of the present disclosure, a method of determining an indoor position of a mobile electronic device within a target building is provided. The method may comprise: receiving, at a backend device, a venue communication comprising venue information from a positioning platform of the mobile electronic device, wherein the venue information comprises coarse location information for the mobile electronic device, a search radius, and a customer license string; validating, via the backend device, a customer identity based on the customer license string received in the venue communication; identifying, via the backend device, one or more building datasets based on the venue information received from the positioning platform of the mobile electronic device in the venue communication, wherein the one or more building datasets includes at least a building dataset corresponding to the target building; generating, via the backend device, an indoor positioning dataset based on the one or more identified building datasets; and transmitting, via backend device, the indoor positioning dataset to the positioning platform of the mobile device. In particular aspects, the indoor position of the mobile electronic device is determined using the indoor positioning dataset received from the backend device.

In an aspect, the venue information may further comprise one or more local location identifiers received at the mobile electronic device from one or more beacon devices positioned within the target building.

In an aspect, the indoor position of the mobile electronic device may be determined within an accuracy of about 30 cm or less.

In an aspect, the method may further comprise: retrieving, via the mobile electronic device, coarse location information for the mobile electronic device; receiving, via the mobile electronic device, one or more local location identifiers from one or more beacon devices positioned within the target building; transmitting, from the positioning platform of the mobile device, the venue communication to the backend device via a communications network; receiving, at the mobile electronic device, the indoor positioning dataset from the backend device via the communications network; and determining, via the positioning platform of the mobile electronic device, the indoor position of the mobile electronic device based on the received indoor positioning dataset.

In an aspect, generating the indoor positioning dataset may include merging two or more building datasets into a super building dataset to form the indoor positioning dataset.

In an aspect, merging the two or more building datasets into a super building dataset may comprise: identifying two or more building datasets based on the venue information, wherein each of the two or more building datasets comprises a record of a plurality of beacon devices, each record comprising a stored local location identifier for each of the plurality of beacon devices and a location of each of the beacon devices within a single building; and generating the super building dataset such that the super building dataset comprises a merged record of a plurality of beacon devices, wherein the merged record comprises a stored local location identifier for each of the plurality of beacon devices and a location of each of the beacon devices within all of the two or more buildings.

According to another embodiment of the present disclosure, an indoor positioning system is provided. The indoor positioning system may comprise: a backend device and a positioning platform of an associated mobile electronic device, the mobile electronic device being communicatively coupled to the backend device. In particular aspects, the backend device may comprise a processor, a memory, and instructions stored in the memory that, when executed by the processor of the backend device can perform one or more of the following: receive a venue communication comprising venue information from the mobile electronic device; validate a customer identity based on a customer license string received in the venue communication; identify one or more building datasets based on the venue information of the received venue communication; generate an indoor positioning dataset based on the one or more identified building datasets; and transmit the indoor positioning dataset to the mobile electronic device. In further aspects, the positioning platform may comprise a memory and instructions stored in the memory that, when executed by a processor of the associated mobile electronic device, can perform one or more of the following: retrieve coarse location information for the mobile electronic device; receive one or more local location identifiers from one or more beacon devices; store a record of the one or more local location identifiers in the memory of the positioning platform; transmit a venue communication comprising venue information to the backend device; receive an indoor positioning dataset from the backend device in response to transmitting the venue communication; and determine an indoor position of the mobile electronic device based on the one or more received local location identifiers and the received indoor positioning dataset.

In an aspect, the venue information may comprise coarse location information for the mobile electronic device, a search radius, and a customer license string.

In an aspect, the venue information may further include a record of one or more local location identifiers received from one or more beacon devices.

In an aspect, the record of the one or more local location identifiers may include at least two local location identifiers received from at least two beacon devices.

In an aspect, each of the one or more local location identifiers may be at least one of a visible coded light (VCL) identifier and a Bluetooth (BLE) identifier.

In an aspect, the system may further comprise: a plurality of beacon devices, wherein each beacon device may comprise a driver that emits a local location identifier associated with the beacon device.

In an aspect, each of building datasets identified based on the venue information may comprise a record of a plurality of beacon devices, a local location identifier associated with each of the plurality of beacon devices, and a location of each of the plurality of beacon devices within a single building.

In an aspect, the indoor positioning dataset generated by the backend device may comprise the one or more identified building datasets merged into a super building dataset.

In an aspect, the backend device may further comprise instructions stored in the memory of the backend device that, when executed by the processor of the backend device, can perform the following: identify two or more building datasets based on the venue information, each of identified building datasets comprising a record of a plurality of beacon devices, a local location identifier associated with each of the plurality of beacon devices, and a location of each of the plurality of beacon devices within a single building; and generate the super building dataset such that the super building dataset comprises a merged record of a plurality of beacon devices.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a diagram of a selection of a building based on distance of a device from a location of the building according to certain aspects of the present disclosure.

FIG. 2 is a diagram of a densely-packed geographic region having multiple buildings and an indoor positioning system according to certain aspects of the present disclosure.

FIG. 3 is a diagram illustrating an indoor positioning system according to certain aspects of the present disclosure.

FIG. 4 is a block diagram schematic of a luminaire used in an indoor positioning system according to the present disclosure.

FIG. 5 is a block diagram of a computing environment according to an example implementation of the present disclosure.

FIG. 6 is a flowchart illustrating a method of detecting and tracking the indoor position of a mobile device according to the present disclosure.

FIG. 7 is a flowchart illustrating further aspects of a method of detecting and tracking the indoor position of a mobile device according to the present disclosure.

### DETAILED DESCRIPTION OF EMBODIMENTS

The subject matter of the present disclosure is directed to enabling positioning systems for detecting a device location. In an indoor positioning enabled system, a mobile device that runs a positioning software (e.g., IPS SDK) can detect the device location with high location accuracy using various technologies such as visual light communication (VLC), Bluetooth, and the like.

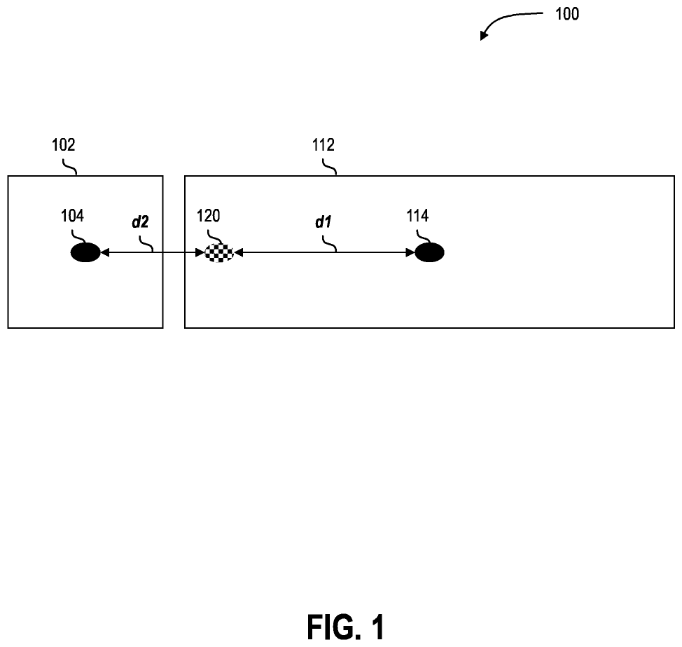

Additionally, the present disclosure provides indoor positioning systems and methods of indoor positioning and navigation at geographical locations where multiple potential buildings or sites are closely spaced together (i.e., where a mobile device may be incorrectly positioned within a different building as shown in FIG. 1 and discussed above) based on the native location capabilities of the mobile device. For example, when an indoor positioning system detects a user within a geographical site that has multiple buildings close together, identifying the correct building can be problematic, resulting in failed or erroneous indoor positioning, and also creates the issue of building switching. As shown in FIG. 1, for example, a diagram 100 is provided depicting a first building 102, a center 104 of the first building 102, a second building 112, a center 114 of the second building 112, and a device 120 located in the second building 112. The distance dl between the device 120 and the center 114 of the second building 112 is larger than the distance d2 between the device 120 and the center of the first building 102. As a result, a conventional indoor positioning system could mistake the device 120 as being inside the first building 102 rather than the second building 112, and erroneously return indoor positioning information for the first building 102.

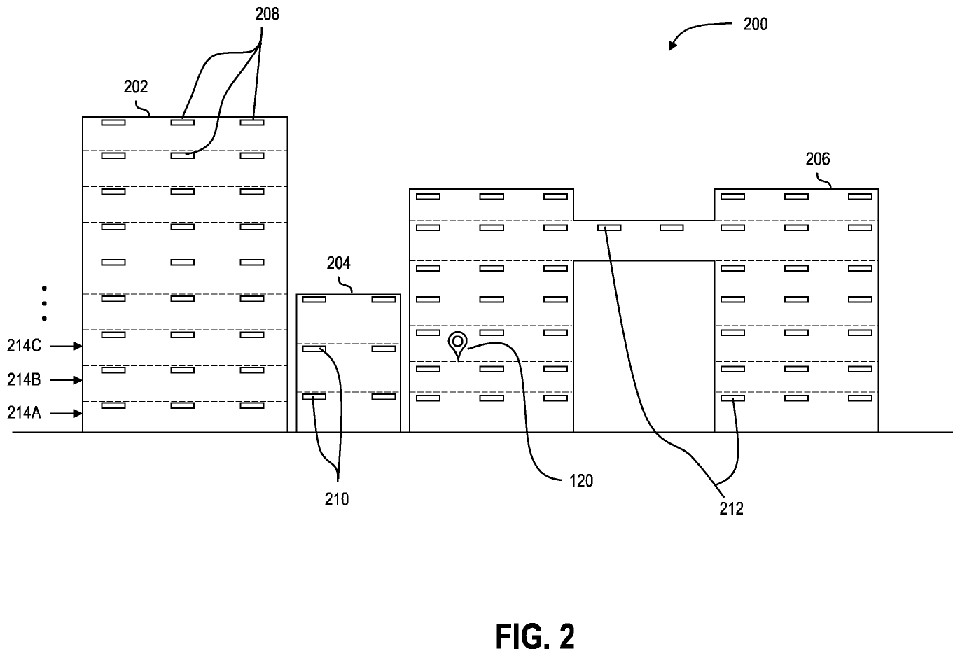

Turning to FIG. 2, another geographic location 200 having multiple buildings closely spaced together is illustrated. As shown, the location 200 includes one or more buildings, such as a first multistory building 202, a second multistory building 204, and a third multistory building 206, etc. Each building 202, 204, 206 can include a plurality of geolocation beacons 208, 210, 212, respectively, which can be used as part of an indoor positioning system for detecting the location a mobile device 120 (e.g., for navigation) within one or more of the buildings 202, 204, 206 of the geographic location 200. It will be appreciated that the plurality of geolocation beacons 208, 210, 212 can be distributed and/or installed across multiple floors 214A, 214B, 214C, etc. of each of the buildings 202, 204, 206 within the geographic location 200 in various configurations and arrangements. For example, the plurality of geolocation beacons 208, 210, 212 can be distributed/installed on each of the floors 214A, 214B, 214C within a building 202, 204, 206, or can be distributed/installed on only selected floors 214A, 214B, 214C and/or select portions of the buildings 202, 204, 206.

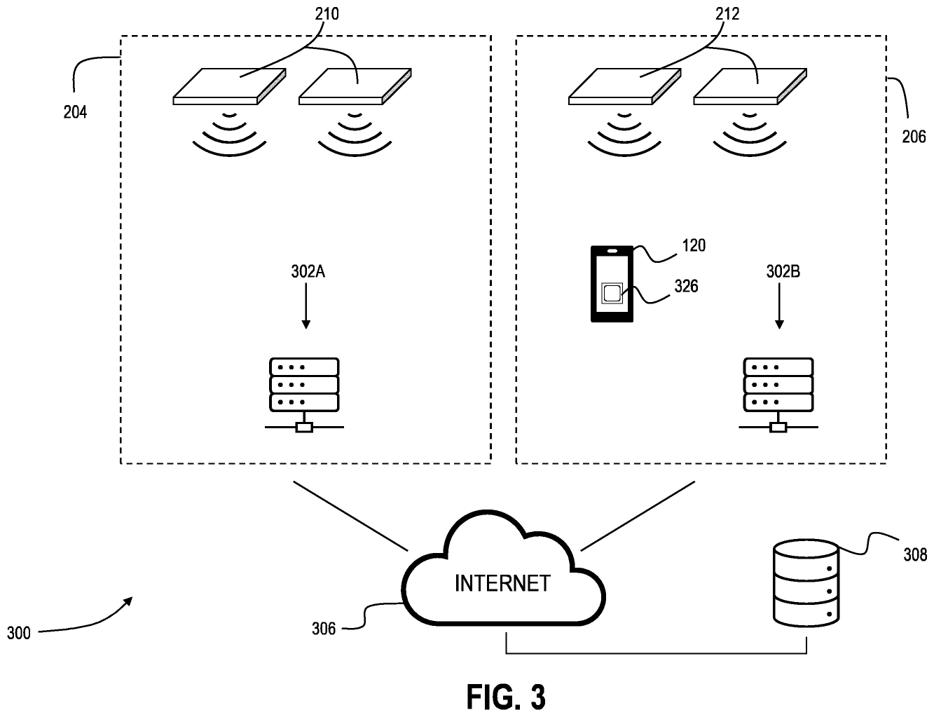

The mobile device 120 (e.g., mobile electronic device) is illustrated in FIG. 3 for example purposes as a mobile electronic device. However, it should be appreciated that the mobile device 120 can include a variety of different types of computing systems and/or positioning systems. In embodiments, mobile device 120 can include a computing system (e.g., computing system 514), a smartphone, other mobile phones, a tablet computer, handheld computing device, wearable computing device, desktop computer, laptop computer, and/or implemented with other forms of computing devices able to communicate, transmit and/or receive data, such as but not limited to position data.

With reference to FIG. 3, a schematic diagram showing an indoor positioning system 300 for use in geographic locations with closely spaced buildings 202, 204, 206 is provided. As illustrated, the indoor positioning system 300 includes a plurality of geolocation beacons 210 associated with a second building 204 and a plurality of geolocation beacons 212 associated with a third building 206. The indoor positioning system 300 further includes a mobile electronic device 120 configured to run (e.g., execute) a positioning platform 326 and a remote backend device 308 (i.e., not located within the buildings 204, 206). In embodiments, the indoor positioning system 300 can also include one or more local backend devices 302A, 302B located on site (e.g., within each of the indoor positioning enabled buildings 202, 204, 206), which can work alone or in combination with the backend device 308. In embodiments, the mobile device 120 can be operatively connected (e.g., communicatively coupled) to the remote backend device 308 and/or local backend device 302A, 302B via a communications network 306, including, for example, a wired network (e.g., Ethernet) and/or wireless network implementing various RF data communication standards such as Wi-Fi, Bluetooth, or cellular data network standards (e.g., 3G, 4G, 5G, 60 GHz, LTE, etc.). The mobile device 120 can be communicatively coupled to the remote backend device 308 and/or local backend device 302A, 302B via a communications network 306 to transmit and receive data, including but not limited to, location identifiers, venue communications, building datasets, positioning data, indoor positioning data, and/or merged building datasets. In embodiments, the positioning platform 326 can be executing on the mobile electronic device 120 to communicate with the one or more local backend devices 302A, 302B, and/or one or more remote backend devices to transmit position data and/or receive position data. The position data can include, but is not limited, position and geographic location data associated with one or more buildings 204, 206, 208 and/or a position of the mobile electronic device 120 within or relative to the one or more buildings 204, 206, 208. In embodiments, the positioning platform 326 can include a processor and/or processing units (e.g., processing units 518) to communicate with the one or more local backend devices 302A, 302B, and/or one or more remote backend devices to transmit position data and/or receive position data. In embodiments, the positioning platform 326 can include instructions that, when executed by a processor of the mobile device 120, cause the mobile device 120 to perform methods 600 and 700 as described herein. In embodiments, the positioning platform 326 can include instructions that, when executed by a processor of the positioning platform 326, cause the positioning platform 326 to perform methods 600 and 700 as described herein.

As shown in FIG. 2 and FIG. 3, each of the indoor positioning enabled buildings 202, 204, 206 can include a plurality of geolocation beacons 208, 210, 212. In embodiments, each of these geolocation beacons can be provided as a part of a beacon device. In specific embodiments, one or more of the beacon devices can be a luminaire and the indoor positioning system 300 includes a plurality of luminaires 208, 210, 212 configured to emit a geolocation beacon.

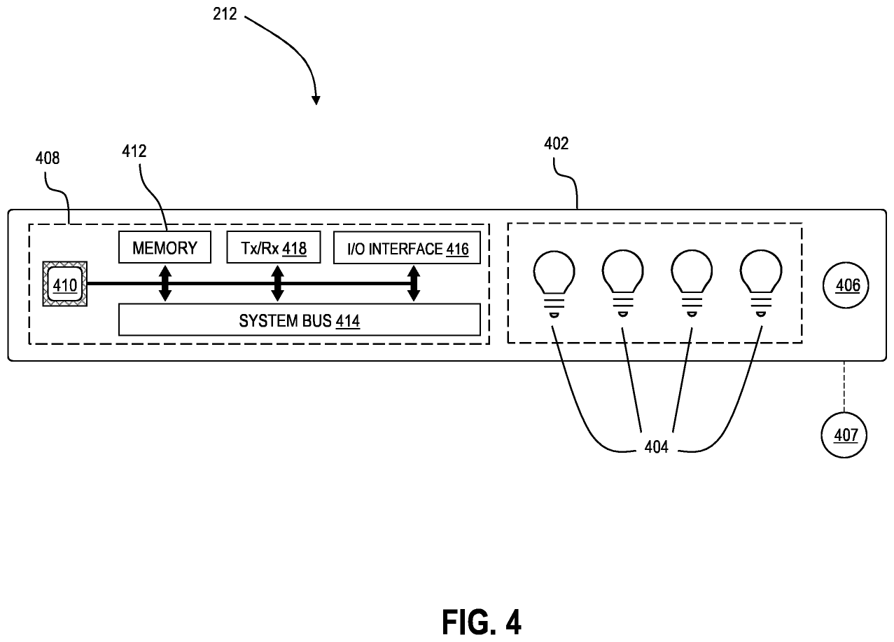

With reference to FIG. 4, a block diagram schematic of an exemplary luminaire 212 is illustrated. The luminaire 212 includes one or more lamps 404 (e.g., light emitting diodes (LEDs), light fixture, lighting device) and a driver 408 located within a housing 402. The luminaire 212 can be connected to an external power supply 407 and/or include an internal power supply 406 that powers one or more components of the luminaire 212 (e.g., the driver 408). The driver 408 can include one or more processors 410, a memory 412, a transceiver/receiver 418, an input/output interface 416, and a system bus 414 connecting each of the components of the driver 408 together. The transceiver/receiver component 418 can be configured to communicate (e.g., transmit data, receive data) with devices within a range of the respective luminaire 212. For example, the transceiver/receiver component 418 can be configured to communicate (e.g., transmit data, receive data) with one or more mobile electronic devices 120 within a communication range (e.g., based in part on properties a communications network 306) of the respective luminaire 212 The transceiver/receiver component 418 can be configured to emit a local location identifier. In embodiments, the local location identifier can be emitted in the form of a coded light signal such as a visible light communication (VLC). In other embodiments, the local location identifier can be emitted using Bluetooth (i.e., in the form of Bluetooth identifiers, Bluetooth Low Energy identifiers, and the like), and/or other wireless communication protocols that can transmit a mobile device identifier.

In embodiments, the driver 408 can be programmed to emit a particular local location identifier that is programmed at the time of manufacturing or can be programmed later (e.g., during installation of the luminaire 212). In specific embodiments, the local location identifier can be a 16-bit string (or integer). In such embodiments, the local location identifier may or may not be unique to a particular indoor positioning enabled building (e.g., buildings 202, 204, 206).

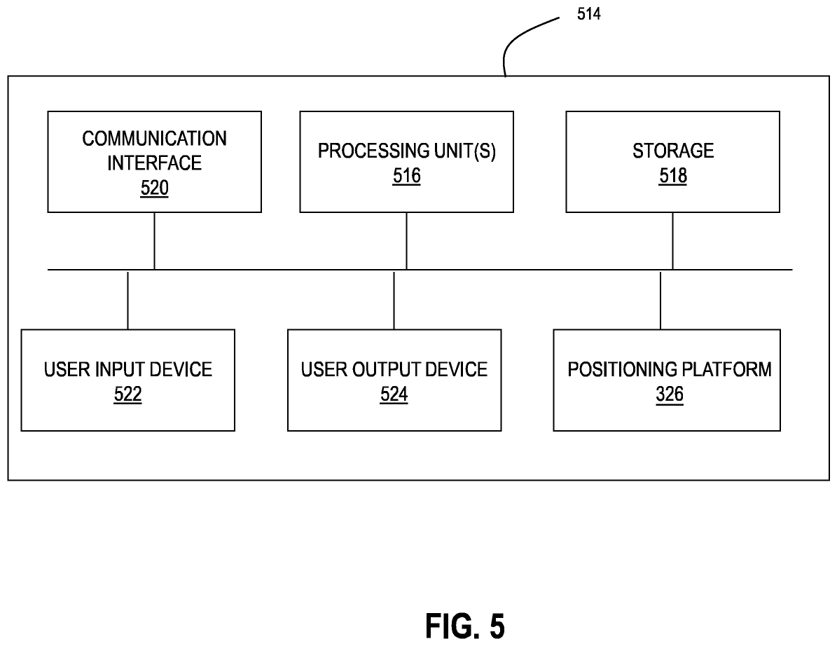

Turning to FIG. 5, various operations described herein can be implemented using one or more computer systems 514. In some embodiments, the indoor positioning system described herein (e.g., indoor positioning system 300, mobile device 120, backend device 308, local backend device(s) 302A, 302B) can be implemented by the comprising system 514. Computing system 514 can be implemented, for example, as one or more servers, cloud computing devices, backend servers, mobile devices, smartphones, other mobile phones, tablet computers, wearable computing devices, desktop computers, laptop computers, and/or implemented with distributed computing devices. The computing system 514 can be implemented to provide or enable indoor positioning systems, for example, for determining the location of one or more devices within an environment, building, or other form of space or structure. In some embodiments, the computing system 514 can include computer components such as processors 516, storage device 518, communication interface 520, user input device 522, and user output device 524.

In embodiments, the communication interface 520 can provide connection to a wide area network (e.g., the Internet) to which WAN interface of a remote server system (e.g., backend device 308) can also be connected. The network interface 520 can include a wired interface (e.g., Ethernet), a wireless interface implementing various RF data communication standards such as Wi-Fi, Bluetooth, or cellular data network standards (e.g., 3G, 4G, 5G, 60 GHz, LTE, etc.), and/or a wireless interface implementing VLC data communication.

User input device 522 can include any device or devices via which a user can provide signals or commands to computing system 514. The computing system 514 can interpret these signals and commands as indicative of particular user requests or information (e.g., positioning data, location data, etc.) via the processors 516. The user input device 522 can include one or more of a keyboard, touchpad, touch screen, mouse or other point device, scroll wheel, click wheel, dial, button, switch, keypad, microphone, cameras (e.g., ultra-wide-angle, wide-angle telephoto, periscope, monochrome, macro, time-of-flight, etc.), other sensors (e.g., a motion sensor, eye tracking sensor, etc.), and the like. In particular, the user input device 522 can include a camera that receives signals such as VLC signals.

User output device 524 can include any device via which computing system 514 can provide information (e.g., positioning data, location data, etc.), requests, and/or notifications to a user. For example, user output device 524 can include a display to display images generated by or delivered to the computing system 514. The display can incorporate various image generating technologies, such as a liquid crystal display (LCD), light-emitting diode (LED) including organic light-emitting diodes (OLED), projection system, cathode ray tube (CRT), or the like, together with supporting electronics (e.g., digital-to-analog or analog-to-digital converts, signal processors, or the like). A device such as a touchscreen that functions as both input and output device can also be used. Output devices 524 can be provided in addition to or instead of a display. Examples include indicator lights, speakers, tactile “display” devices, printers, and so on.

In particular embodiments, the computing system 514 (e.g., the indoor positioning system 300) can include a positioning platform 326 comprising instructions that, when executed by the processing unit(s) 516, perform one or more steps of method 600 and/or method 700 described herein. In embodiments, the positioning platform 326 can execute on the computing system 514 to communicate with the one or more local backend devices 302A, 302B, and/or one or more remote backend devices to receive and transmit data, including but not limited to, position data, geographic location data, local location identifiers, beacon identifiers, VCL identifiers, BLE identifiers, coarse location information, venue information, indoor positioning datasets, building datasets, super building datasets, and/or customer license string. The positioning platform 326 can enable the computing system 514 (e.g., mobile electronic device 120) the positioning platform 326 is executing on to determine its respective location (e.g., position, indoor position) relative to a particular environment and/or one or more buildings 202, 204, 206 the computing system 214 is located.

Some implementations include electronic components, such as microprocessors, storage and memory that store computer program instructions in a computer readable storage medium (e.g., non-transitory computer readable medium). One or more of the features described in this specification can be implemented as processes that are specified as a set of program instructions encoded on a computer readable storage medium. When these program instructions are executed by one or more processors, they cause the processors to perform various operations indicated in the program instructions. Examples of program instructions or computer code include machine code, such as is produced by a compiler, and files including higher-level code that are executed by a computer, an electronic component, or a microprocessor using an interpreter. Through suitable programming, processors 516 can provide various functionality for the computing system 514, including one or more of the steps of the methods described herein as being performed by a mobile device, a backend device, or other functionality associated with these devices.

It will be appreciated that the computing system 514 is illustrative and that variations and modifications are possible. Electronic systems 514 used in connection with the present disclosure can have other capabilities not specifically described herein. Further, while computing system 514 is described with reference to particular diagram blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatuses including electronic devices implemented using different combinations of circuitry and software.

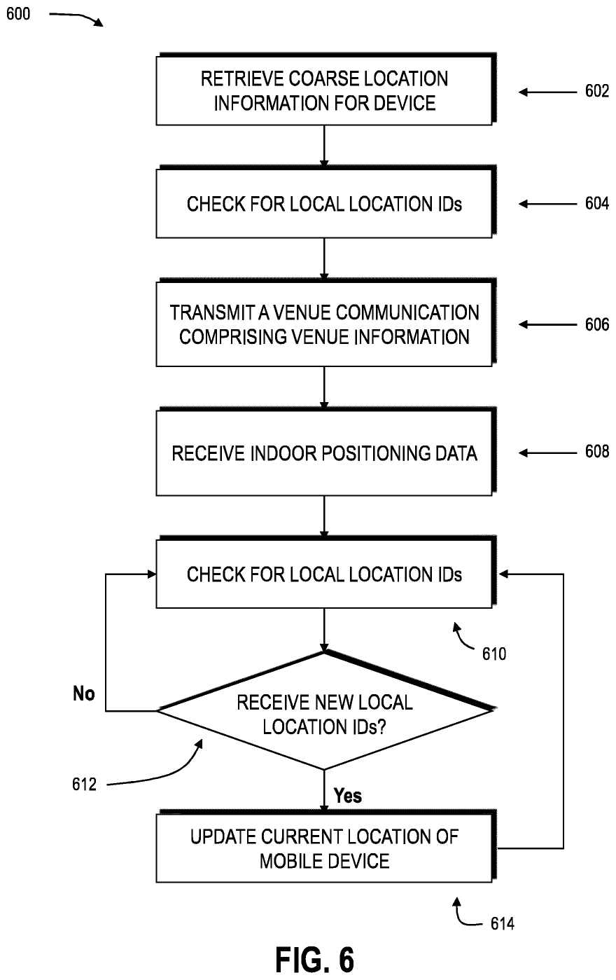

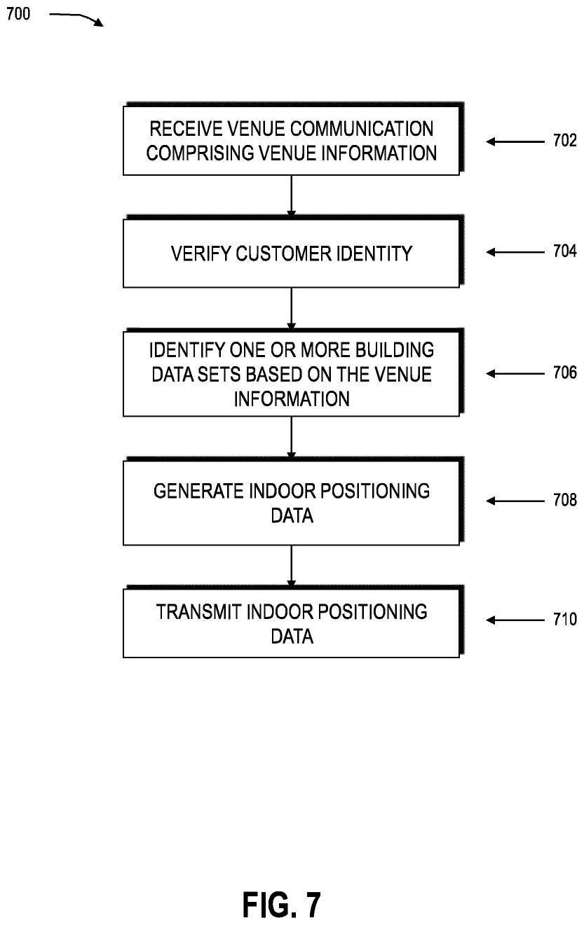

Turning to FIG. 6 and FIG. 7, methods 600, 700 of detecting and tracking the indoor position of a mobile electronic device (e.g., computing system 514, device 120) within an environment having multiple indoor positioning enabled buildings (e.g., buildings 202, 204, 206) closely spaced together are described in accordance with various aspects of the present disclosure. In embodiments, the methods 600 and 700 can be performed or executed by the positioning platform 326 or processor (e.g., processing units 516) to enable determination of a location of (e.g., indoor position, outdoor position) an electronic device (e.g., computing system 514, device 120) relative to one or more buildings 202, 204, 206.

With reference to FIG. 6, a method 600 is illustrated in certain aspects. The method 600 includes a step 602 of retrieving coarse location information for the mobile device to be tracked. In particular, the backend device can transmit a request to the mobile device for coarse location information, which may be received at the mobile device and processed via the positioning platform 326 of the mobile device. Upon receiving such a request, if appropriate, the mobile device can respond by transmitting coarse location information for the mobile device obtained using the native location capabilities of the mobile device. In embodiments, the positioning platform 326 can respond by transmitting coarse location information for the mobile device obtained using the native location capabilities of the mobile device or position data stored locally at the mobile device. In embodiments, coarse location information can include, but is not limited to, the rough latitude, longitude, and/or altitude of the mobile device, or other forms of position data collected or determined at the mobile device.

Optionally, the method 600 can include a step 604 of checking/detecting one or more local location identifiers (e.g., from geolocation beacons) via the mobile device. In embodiments, the positioning platform 326 of the mobile device (e.g., mobile device 120) can use one or more input devices (e.g., user input devices 522) to detect the one or more local location identifiers. For example, the input devices 522 can include one or more types of cameras configured to receive a signal in the form of a VCL identifier. In embodiments, the positioning platform 326 of the mobile device (e.g., mobile device 120) can use one or more of the components of the communications interface 520 to detect the one or more local location identifiers. For example, the communications interface 520 can include a Bluetooth transmitter/receiver configured to receive a signal in the form of a Bluetooth identifier.

Then, in a step 606, the method 600 includes transmitting a venue communication message comprising venue information to a backend device (e.g., backend device 308 and/or backend devices 302A, 302B) via the mobile electronic device. The positioning platform 326 can transmit the venue communication message including the venue information to one or more backend devices. In embodiments, the positioning platform 326 can establish a connection or maintain a connection to the backend device (or multiple backend devices) to transmit and/or receive data. In embodiments, venue information can include the coarse location information (e.g., latitude and longitude) as well as other information, such as a customer license string stored in memory of the mobile device, a search radius (e.g., a distance from the mobile device to search for indoor positioning enabled buildings), and/or one or more local location identifiers detecting in step 604.

To make this process 600 scalable, the environment (e.g., building, site, campus, office, etc.) can be selected first prior to receiving indoor positioning dataset (e.g., in a step 608). In embodiments, the selection can be performed in one or more different steps, as described herein. In some embodiments, the selection can be performed manually, for example, through the mobile electronic device 120 (e.g., a computing device 514) and/or through the positioning platform 326 executing on the mobile electronic device 120. In some embodiments, the selection can be automated or an environment can be selected for the mobile device. For example, a selection can be performed at a mobile device platform (e.g., positioning platform 326), via a processor of the mobile device, using the venue information (including the coarse location information) for the mobile device. In embodiments, the selection of the environment (e.g., building(s)) can be automatic based in part on an initial coarse location of the respective mobile device.

Further, the systems and methods described herein can include an indoor positioning system that selects the environment based on a device location in combination with a license string. As used herein, the term “license string” refers to a series of computer-readable characters that can be used to control access to the indoor positioning systems and positioning information described herein. The license string may be used to uniquely identify one or more users, organizations, clients, customers, or the like. In embodiments, the license string can include a mechanism to scope the search for the venues/buildings, for example, within the context of a single customer. For example, a first license string may unlock access to indoor positioning information for two of ten positioning-enabled buildings within a confined geographic region, while a second license string may unlock access to indoor positioning information for at least a third positioning-enabled building within the same geographic region.

More specifically, in embodiments, at step 602, the method 600 can include having the indoor positioning system (e.g., indoor positioning software development kit (SDK) running on a mobile device) request (e.g., query, search) a current location from a computing device, positioning system, server (e.g., backend device, backend server, cloud computing system), and/or mobile platform. In some embodiments, the indoor positioning system can make the request in the form of a call to a backend device and the request can include or request the following parameters: a location (e.g., latitude, longitude) that it received from the mobile platform; a license string (e.g., received from an application that the SDK of the indoor positioning system is used in); and/or a search radius. In embodiments, the backend device can include, but is not limited to, a server, backend server, cloud computing device, computing device, and/or central management system.

At a step 608, the method 600 can include receiving, at the mobile electronic device, an indoor positioning dataset from the backend device (e.g., one or more of backend devices 302A, 302B, 308). In embodiments, the positioning platform 326 can receive the indoor positioning dataset from the backend device. In embodiments, the data that is used for positioning and navigation with high accuracy (e.g., VLC/BLE beacon geolocations and their identifiers) can be received, for example, downloaded from a server (e.g., a backend device, backend server) or a control device by the mobile electronic device 120 and/or the positioning platform 326. The indoor positioning dataset can be generated by the backend device of the indoor positioning system (as discussed below with respect to FIG. 7) and can include the individual building datasets for the respective group of buildings and positioning (e.g., location, coordinate data) for each of the respective buildings. In specific embodiments, indoor positioning dataset can include a record of a plurality of geolocation beacons (i.e., beacon devices) installed within the identified buildings, where the record comprises a stored local location identifier for each of the plurality of geolocation beacon and a location or an approximate location of each of the beacons within a single building. In embodiments, a beacon device can be a luminaire or part of a luminaire, or can be a specific Bluetooth beacon device (i.e., not a luminaire).

The positioning platform 326 of the mobile device (e.g., the SDK of the indoor positioning system) can process the individual datasets to identify a device location with a high degree of accuracy (e.g., within less than one meter, within less than 50 cm, within less than 30 cm, and/or within less than 10 cm). For example, in certain embodiments, the positioning platform 326 can include instructions that, when executed by a processor of the mobile device, uses the received positioning dataset or datasets and the received local location identifier(s) from a beacon device(s) 208, 210, 212 to determine the position of the mobile device 120 relative to one or more beacon devices 208, 210, 212.

In embodiments, the indoor positioning platform 326 (e.g., SDK of the positioning system) can perform the building switching or switching between individual building datasets in the background or such that the switching is not visible or noticeable to the user and provides a smooth user experience. For example, when multiple buildings are found within the search radius, the coded light and/or identifiers detected in step 604 can be used in a request or call to the backend device for identification of the building from the multiple buildings. The positioning system (e.g., SDK of positioning system) can wait until it has seen one or more local location identifiers (e.g., VLC identifiers, BLE identifiers, etc.) or a threshold number (e.g., at least 1, at least 2, at least 3, etc.) of identifiers before generating a request and/or call to the backend device for the indoor positioning dataset (e.g., before performing step 606). The threshold number can vary and can be selected based at least in part on a number of buildings in a particular area and/or determined by the user or positioning platform 326 of the mobile device. As such, the request (i.e., the venue communication) can include the one or more local location identifiers received at or seen at the mobile electronic device, and/or a pattern of at least two local location identifiers (e.g., pattern of at least two VLC/BLE identifiers, and the like). For example, the at least two local location identifiers can include between three and ten local location identifiers, or at least ten local location identifiers. The identifier data and pattern data associated with the identifiers can be included in the request with the other venue information/building parameters (e.g., latitude, longitude, search radius, license string).

Thus, at step 608, the mobile device receives the indoor positioning dataset from the backend device necessary to navigate through the appropriate environment (e.g., one or more indoor positioning enabled buildings 202, 204, 206, etc.). Then for further navigation, at a step 610, the method 600 includes checking/detecting one or more additional local location identifiers from one or more geolocation beacons within the identified environment, as described above. In embodiments, the mobile device 120 and/or the positioning platform 326 can check and/or detect for one or more additional local location identifiers from one or more geolocation beacons within the identified environment. In some embodiments, the positioning platform 326 can include instructions that, when executed by a processor of the mobile device 120, cause the mobile device 120 to check and/or detect for one or more additional local location identifiers from one or more geolocation beacons within the identified environment. At steps 612 and 614, the method 600 includes determining whether new local location identifiers were detected, and if so, using the received indoor positioning dataset to update the current location of the mobile electronic device to a high degree of accuracy. In embodiments, the mobile device 120 and/or the positioning platform 326 can determine whether new local location identifiers were detected, and if so, use the received indoor positioning dataset to update the current location of the mobile electronic device. In some embodiments, the positioning platform 326 can include instructions that, when executed by a processor of the mobile device 120, cause the mobile device 120 to determine whether new local location identifiers were detected, and if so, use the received indoor positioning dataset to update the current location of the mobile electronic device. In embodiments, the method 600 can include repeatedly checking for additional local location identifiers and updating the current location of the mobile device as needed. For example, the method 600 can return to step 610 to continually check/detect for one or more additional local location identifiers from one or more geolocation beacons within the identified environment, as described above. In embodiments, if the local location identifiers that are detected are not found within the indoor positioning data, the process of retrieving indoor positioning dataset can be restarted.

With reference to FIG. 7, further aspects of the methods described herein are provided. As illustrated, the method 700 describes certain steps performed by the backend device (e.g., one or more of backend devices 302A, 302B, 308) of the indoor positioning system (e.g., system 300), for example, that can occur between steps 606 and 608 shown in FIG. 6.

At step 702, the backend device can receive a venue communication and a request for indoor positioning data from a mobile device 120 and/or the positioning platform 326 of a mobile device 120. For example, the backend device can receive the venue communication and request for indoor positioning data via a communications network, as described herein. In embodiments, the venue information can comprise one or more of: the latitude associated with the current position of the mobile device; the longitude associated with the current position of the mobile device; a search radius; and a customer license string.

At a step 704, once the backend device receives the venue communication and request from the positioning platform 326 and/or mobile device 120, the backend device can validate a customer identity associated with the request and/or mobile device. For example, the venue communication can include a customer license string that may correspond to a particular customer in a list of customers. In other embodiments, the particular device making the request and sending the venue communication may be associated with a particular customer, in which case the backend device may recognize the mobile device as being associated with that particular customer. In embodiments, the backend device can verify if the license is valid. For example and without limitation, the backend device can compare the customer license string received with the venue communication and compare it with a list of valid licenses.

At step 706, the backend device can search for buildings/building datasets associated with the customer identity and the venue information provided by the mobile device. As used herein, the term “customer identity” refers to a unique means of identifying a customer using an indoor positioning system as described herein. For example, a customer can include an individual, group, organization, business, company, or the like, with a positioning-enabled venue (e.g., buildings, campuses, floors of a building, etc.) A “customer identity” can be a represented using string of characters that distinguish the company from others (e.g., “Company A”, “Company B”, “Company C”, etc.), or can include additional other identifiers (numbers, special characters, etc.).

In embodiments, the backend device can use a search radius (e.g., defined distance from a current location of the customer and/or device) to identify one or more buildings associated with the customer and/or mobile device. The backend device can select the building that is closest (e.g., nearest, least distance) to the customer location and/or device location. In embodiments, the closest building or nearest building can be measured or refer to a distance between the customer location/device location and the location of the respective building (e.g., latitude coordinate, longitude coordinate, configured during commissioning of the building). In embodiments, the buildings not having a valid license or a license matching the venue communication can be removed from the group of identified buildings.

At step 708, the one or more buildings that are within the search radius for the customer and/or device can be identified and a set of buildings may be generated, if multiple buildings are identified. In other words, at step 708, the backend device can generate an indoor positioning dataset for the identified building(s). In embodiments, the indoor positioning dataset generated by the backend system can include a set of geolocation and local identifiers for each beacon device for the identified building(s), which can be used by the mobile device of the indoor positioning system for accurate positioning and navigation. The positioning data (e.g., indoor positioning data) for the identified buildings can be generated, where each building from the remaining buildings has its own single dataset unique to that building.

In embodiments, the indoor positioning systems described herein can merge the multiple building data into a single dataset, generate individual datasets with each dataset representing a single building, and/or include one or more local location identifiers seen in a call to the backend device. In particular, when multiple buildings are found within the search radius, the indoor positioning dataset of the multiple buildings can be merged into a single dataset (e.g., one “super” building dataset) containing each of the multiple buildings together. In embodiments, the merged dataset can appear or represent a single “large” or “super” building that represents all of the identified buildings in the merged dataset. As such, the positioning system (e.g., SDK of the positioning system) can process the merged dataset to identify a device location, for example, without having to switch between different buildings or between different datasets representing different buildings.

In embodiments, the positioning data for the group of identified buildings can be merged into a single dataset with the buildings and their associated data organized within the dataset based in part on a distance determined for the respective buildings. For example, the building having the smallest or lowest distance (e.g., closest distance to the customer and/or device) can be in a first position or data entry of the single dataset for the group of identified buildings. The number of buildings included or to be included in the merged dataset can vary and be selected based in part on the number of identified buildings in the search radius, properties of a location of the customer and/or device (e.g., building density, urban, rural), and/or settings provided by an administrator and/or customer. In embodiments, the number of buildings included in the merged dataset can be limited to a configurable number, for example, set by an administrator and/or customer, to limit the size of the indoor positioning dataset returned (at step 710).

In embodiments, the merged dataset can provide a smooth user experience as there is no building switching needed in an application used to identify the device location. In particular embodiments, the merged dataset can be saved or stored in a non-transitory memory of one or more backend devices so that the merged dataset can be retrieved in the future without the need to be merged for each instance of use.

At step 710, after generating a response, the backend device can transmit the response (i.e., the indoor positioning data) to the positioning platform 326 (e.g., positioning system, to the SDK of the positioning system). In embodiments, the indoor positioning dataset can be transmitted to the mobile device (e.g., device 120) of the indoor positioning system for indoor positioning and indoor navigation as described with respect to FIG. 6.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, solid-stage storage devices such as flash-based solid-state storage devices (e.g., SD card, micro SD cards, SSD, USB flash drive, etc.), or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A method of determining position data of a mobile electronic device within a building, the method comprising:
receiving, at a backend device, a communication comprising venue information from a positioning platform of the mobile electronic device, wherein the venue information comprises coarse location information for the mobile electronic device, a search radius, and a customer license string;
validating, via the backend device, a customer identity based on the customer license string received in the communication;
identifying, via the backend device, one or more building datasets associated with the validated customer identity and based on the venue information received from the positioning platform of the mobile electronic device in the communication, wherein the one or more building datasets includes at least a building dataset corresponding to the building;
generating, via the backend device, an indoor positioning dataset based on the one or more identified building datasets; and
transmitting, via backend device, the indoor positioning dataset to the positioning platform of the mobile device;
wherein the indoor position of the mobile electronic device is determined using the indoor positioning dataset received from the backend device.

2. The method of claim 1, wherein the venue information further comprises one or more local location identifiers received at the mobile electronic device from one or more beacon devices positioned within the building.

3. The method of claim 1, wherein the indoor position of the mobile electronic device is determined within an accuracy of 1 meter or less.

4. The method of claim 1, further comprising:
retrieving, via the mobile electronic device, coarse location information for the mobile electronic device;
receiving, via the mobile electronic device, one or more local location identifiers from one or more beacon devices positioned within the building;
transmitting, from the positioning platform of the mobile device, the communication to the backend device via a communications network;
receiving, at the mobile electronic device, the indoor positioning dataset from the backend device via the communications network; and
determining, via the positioning platform of the mobile electronic device, the indoor position of the mobile electronic device based on the received indoor positioning dataset.

5. The method of claim 1, wherein the generating the indoor positioning dataset includes merging two or more building datasets into a super building dataset to form the indoor positioning dataset.

6. The method of claim 5, wherein merging the two or more building datasets into a super building dataset comprises:
identifying two or more building datasets based on the venue information, wherein each of the two or more building datasets comprises a record of a plurality of beacon devices, each record comprising a stored local location identifier for each of the plurality of beacon devices and a location of each of the beacon devices within a single building; and
generating the super building dataset such that the super building dataset comprises a merged record of a plurality of beacon devices, wherein the merged record comprises a stored local location identifier for each of the plurality of beacon devices and a location of each of the beacon devices within all of the two or more buildings.

7. An indoor positioning system comprising:
a backend device and a positioning platform of an associated mobile electronic device, the mobile electronic device being communicatively coupled to the backend device;
wherein the backend device comprises a processor, a memory, and instructions stored in the memory, when executed by the processor of the backend device causes the processor to:
receive a communication comprising venue information from the mobile electronic device;
validate a customer identity based on a customer license string received in the communication;
identify one or more building datasets associated with the validated customer identity and based on the venue information of the received communication;
generate an indoor positioning dataset based on the one or more identified building datasets; and
transmit the indoor positioning dataset to the mobile electronic device;
wherein the positioning platform comprises a memory and instructions stored in the memory that, when executed by a processor of the associated mobile electronic device, causes the processor to:
retrieve coarse location information for the mobile electronic device;
receive one or more local location identifiers from one or more beacon devices;
store a record of the one or more local location identifiers in the memory of the positioning platform;
transmit a communication comprising venue information to the backend device;
receive an indoor positioning dataset from the backend device in response to transmitting the communication; and
determine an indoor position of the mobile electronic device based on the one or more received local location identifiers and the received indoor positioning dataset.

8. The indoor positioning system of claim 7, wherein the venue information comprises coarse location information for the mobile electronic device, a search radius, and a customer license string.

9. The indoor positioning system of claim 7, wherein the venue information further includes a record of one or more local location identifiers received from one or more beacon devices.

10. The indoor positioning system of claim 7, wherein the record of the one or more local location identifiers includes at least two local location identifiers received from at least two beacon devices.

11. The indoor positioning system of claim 7, wherein each of the one or more local location identifiers is at least one of a visible coded light (VCL) identifier and a Bluetooth (BLE) identifier.

12. The indoor positioning system of claim 7, further comprising:
a plurality of beacon devices, each beacon device comprising a driver that emits a local location identifier associated with the beacon device.

13. The indoor positioning system of claim 7, wherein each of building datasets identified based on the venue information comprise a record of a plurality of beacon devices, a local location identifier associated with each of the plurality of beacon devices, and a location of each of the plurality of beacon devices within a single building.

14. The indoor positioning system of claim 7, wherein the indoor positioning dataset generated by the backend device comprises the one or more identified building datasets merged into a super building dataset.

15. The indoor positioning system of claim 14, wherein the backend device further comprises instructions stored in the memory of the backend device that, when executed by the processor of the backend device, performs the following:
identify two or more building datasets based on the venue information, each of identified building datasets comprising a record of a plurality of beacon devices, a local location identifier associated with each of the plurality of beacon devices, and a location of each of the plurality of beacon devices within a single building; and
generate the super building dataset such that the super building dataset comprises a merged record of a plurality of beacon devices.
